(19) United States
(12) Patent Application Publication
(10) Pub. No.: US 2008/0299243 A1
(43) Pub. Date: Dec. 4, 2008

(54) EXTRUSION CUTTING APPARATUS

(76) Inventor: JAMES M. PINCHOT, Parma, OH (US)

Correspondence Address: FAY SHARPE LLP, 1100 SUPERIOR AVENUE, SEVENTH FLOOR, CLEVELAND, OH, 44114, US

(21) Appl. No.: 12/128,878

(22) Filed: May 29, 2008

Related U.S. Application Data
(60) Provisional application No. 60/932,295, filed on May 30, 2007.
(60) Provisional application No. 60/961,081, filed on Jul. 18, 2007.

(51) Int. Cl. B29C 47/92

(52) U.S. Cl. 425/142

(57) ABSTRACT

An extruder system and a cutting assembly for cutting a material extruded from a die plate.

The present invention claims priority on U.S. Provisional Application Ser. No. 60/932,295 filed May 30, 2007 entitled “Extrusion Cutting Apparatus”, all of which is incorporated herein by reference.

The present invention also claims priority on U.S. Provisional Application Ser. No. 60/961,081 filed Jul. 18, 2007 entitled “Extrusion Cutting Apparatus”, all of which is incorporated herein by reference.

The present invention relates to extrusion hardware, and more particularly to die plates, die plate inserts and cutting devices for use in an extruder system.

### INCORPORATION BY REFERENCE

The following patents and patent applications are incorporated herein by reference to provide background information relating to extruder technology and can be used in and, or with the present invention, namely U.S. Pat. Nos. D442,612; D444,487; D446,794; D450,732; D452,257; D469,116; D469,117; D469,452; D469,453; D469,454; D470,869; D470,870; D472,252; D485,286; D494,198; D496,377: D497,376; D523,452; D531,197; D534,562; D544,005; D544,006; D544,506; D544,891; D562,364; D562,370; D562,857; D562,858; D562,859: D562,860; D562,861; D563,441; D563,442; D564,549; D564,550; D564,551; D565,067; D565,068; D565,610; D565,611; D565,612; D565,613; D565,614; D565,615; D566,145; D568,349; D569,885; and U.S. Patent Application Ser. Nos. 60/548,693 filed Feb. 27, 2004; 11/062,220 filed Feb. 18, 2005; 29/242,613 filed Nov. 10, 2005; 29/242,779 filed Nov. 15, 2005; 29/242,881 filed Nov. 15, 2005; 29/263,364 filed Jul. 14, 2006; 11/651,063 filed Jan. 8, 2007; 29/272,847 filed Feb. 20, 2007; 29/285,094 filed Mar. 21, 2007; 29/285,095 filed Mar. 21, 2007; 29/285.099 filed Mar. 21, 2007; 29/285,108 filed Mar. 21, 2007; 29/285,112 filed Mar. 21, 2007; 29/285/115 filed Mar. 21, 2007; and PCT Application Serial Nos. PCT/US2006/005731 filed Feb. 17, 2006 and PCT/US2007/000300 filed Jan. 8, 2007; and European Patent Nos. 556030-01/04; 556006-001/013; 556022-01/04; and European Patent Application Serial No. 000556022 filed Jul. 4, 2006.

### BACKGROUND OF THE INVENTION

Many types of products are extruded from dies and cut to certain lengths after being extruded through the die. Such products include, but are not limited to, catalyst, human and animal foods, fertilizer, medication, various types of plastic and or other polymer products, fiber reinforced products, metal, glass, etc. For some types of products (e.g., medication, fertilizer, catalyst, etc.) the cut extruded product should be as uniform as possible. The rate at which a certain product is extruded through a particular die can at least partially depend on a variety of factors such as the wearing of the die components, the wearing of the auger, the density of the product, whether the auger is starved of feed material, plugging of one or more die inserts, etc. As a result of one or more of these variable factors and/or other factors, the rate at which a particular product extrudes through one or more dies can periodically vary. This varying of the rate of product extrusion commonly results in the cut extruded product being of a non-uniform length, thereby resulting in a significant percent of the product to be disposed of.

Products formed for the medical and catalyst industry are highly sensitive to product uniformity. The uniform size of a catalyst is used to control certain types of chemical reactions. In some types of chemical reactions, a large tolerance as to size variations was acceptable for the catalyst in these chemical reactions. Due to these large acceptable tolerances as to catalyst size, the catalyst could be extruded and cut using conventional technology and about 65-85% of the cut catalyst would be acceptable for use. However, when the tolerances for the size of the catalyst are small when the catalyst is used in other types of chemical reactions, the amount of wasted cut catalyst significantly increases, thereby increasing product costs. In the medical industry, the tolerance for the size of the medical catalyst is very low so as to ensure that essentially the same dosage of medicine is present in each pill. As such, most drug manufacturers use a pill manufacturing process. Pill machines are also used to form some types of catalyst that require a low tolerance to the size of the catalyst. Although the pill manufacturing process produces a large percentage of medication and catalyst having a desired size, the pill manufacturing process is very expensive as compared with most extrusion processed, and also has extremely slow through-puts, thereby resulting in low output over time and significantly increased manufacturing costs. Such high costs are cost prohibitive for many types of products.

In view of the current state of the art, there is a need for extrusion hardware and a cutting device that can be used to cut an extruded product in a more uniform manner.

### SUMMARY OF THE INVENTION

The present invention relates to extrusion hardware, and more particularly to die plates, extruder die inserts, and cutting devices for use in an extruder system. In one non-limiting embodiment of the invention, there is provided specially designed extruder die inserts and die plates that can to used to extrude a wide variety of different materials. The extruder/die inserts and die plates of the present invention are designed to improve the throughput by an extruder, improve the durability of the die plate and/or extruder/die insert, improve the ease of use of the extruder/die insert in combination with the die plate, and/or improve the quality of the material extruded by the extruder system. In yet another and/or alternative non-limiting embodiment of the invention, there is provided a cutting assembly to cut materials that have been extruded through one or more extruder/die inserts that are positioned in a die plate. The extrusion hardware of the present invention is particularly directed to the extrusion and cutting of an extruded catalyst; however, the extrusion hardware can be used to cut many other types of extruded material.

In one non-limiting aspect of the present invention, there is provided a cutting assembly that is designed to cut materials on one or more types of materials that have been extruded through one or more die plates that may or may not include one or more extruder/die inserts. The improved cutting assembly is designed to improve the product quality of cut extruded material by cutting the extruded material within low tolerances to a certain specified length. In many types of businesses such as, but not limited to, the catalyst business, etc., the size of the extruded material must be maintained to comply with certain criteria. For instance, the size of the catalyst can affect the rate of reaction that takes place when using the catalyst. An extruded catalyst that is cut too large or too small could adversely affect a chemical reaction that involves the use of the catalyst. The proper cutting of other materials (e.g., foods, fertilizers, etc.) can affect the product quality and/or effectiveness of the cut product. The improved cutting assembly of the present invention is designed to cut an extruded product from a die plate to form a cut product that more closely matches the desired length of the product. In addition, the improved cutting assembly of the present invention can be used to cut products that are currently extruded through die plates and thereby significantly reduce the amount of waste of such extruded product that historically has to be disposed of since the extruded product did not meet the size tolerance parameters of the extruded product. As such, one non-limiting aspect of the present invention is thus directed to an extrusion cutting assembly which can increase the quantity of cut product.

In another and/or alternative non-limiting embodiment of the invention, the cutting assembly of the present invention includes a fluid cutting arrangement to cut and/or break material that is extruded through a die plate and/or one or more extruder/die inserts in a die plate. The fluid can be a liquid and/or a gas. In one non-limiting embodiment of the invention, the fluid is a gas. Non-limiting gasses include, but are not limited to, air, nitrogen, stream, noble gasses, etc. In another and/or alternative non-limiting embodiment of the invention, a high pressure fluid is at least partially used to cut and/or break material that is extruded through a die plate and/or one or more extruder/die inserts in a die plate. As defined in herein, high pressure is a pressure of about 20 psig or greater. In one non-limiting aspect of this embodiment, the high pressure fluid used by the cutting assembly of the present invention is at least about 25 psig. In another and/or alternative non-limiting aspect of this embodiment, the high pressure fluid used by the cutting assembly of the present invention is at least about 50 psig. In still another and/or alternative non-limiting aspect of this embodiment, the high pressure fluid used by the cutting assembly of the present invention is at least about 60 psig. In still yet another and/or alternative non-limiting aspect of this embodiment, the high pressure fluid used by the cutting assembly of the present invention is less than about 10,000 psig. In another and/or alternative non-limiting aspect of this embodiment, the high pressure fluid used by the cutting assembly of the present invention is less than about 1,000 psig. In still another and/or alternative non-limiting aspect of this embodiment, the high pressure fluid used by the cutting assembly of the present invention is less than about 500 psig. In still another and/or alternative non-limiting aspect of this embodiment, the high pressure fluid used by the cutting assembly of the present invention is less than about 200 psig. In still another and/or alternative non-limiting embodiment of the invention, a super heated steam can be used solely as the high pressure fluid or be combined with one or more other high pressure fluids (e.g., air, noble gas, etc.). The super heated steam is defined as steam having a temperature of over 110° C., generally over about 150° C., typically at least about 200° C., and more typically at least about 250° C. As can be appreciated, higher temperature super heated steam can be used. The super heated steam, when used, can be used to facilitate in the drying of the material that is extruded through a die plate and/or one or more extruder/die inserts in a die plate. The super heated steam can also or alternatively be used to increase the PV and/or CS of the material that is extruded through a die plate and/or one or more extruder die inserts in a die plate.

In still another and/or alternative non-limiting aspect of the present invention, the cutting assembly of the present invention includes an improved control arrangement which can vary the fluid pressure (e.g., adjust the fluid pressure and/or flowrate, pulse the fluid to/in the cutting assembly, maintain a constant fluid pressure and/or flowrate, etc.) to account for the type of material being extruded through the die plate and/or extruder/die insert, and/or to account for any pressure differentials applied to the material being extruded through the die plate and/or extruder/die insert; however, this is not required. For instance, when the pressure on the extruded material increases, the material typically travels at a faster rate through the die plate and/or extruder/die insert. Conversely, when the pressure on the extruded material reduces, the extruded material typically passes at a slower rate through the die plate and/or extruder/die insert. By detecting the pressure of the material prior to entering one or more openings in the die plate and/or extruder/die insert, and/or as the material enters and/or passes through one or more openings in the die plate and/or extruder/die insert, it can be determined whether the material is accelerating, decelerating, or maintaining a constant velocity through the die plate and/or extruder/die insert. If it is determined that the speed of the material (e.g., via pressure reading, via visual detection, via flow meters, etc.) passing through one or more openings in the die plate and/or extruder/die insert has decreased or increased and/or is going to decrease or increase, adjustments can be made to the fluid pressure of the cutting assembly to account for the change in speed at which the material is exiting the outer surface or face of the die plate and/or extruder/die insert. Furthermore, if it is determined that the speed of the material passing through one or more openings in the die plate and/or extruder/die insert has remained constant and/or is going to remain constant, the fluid pressure of the cutting assembly can also be maintained. Furthermore, the material passing through one or more openings in the die plate and/or extruder/die insert can have different physical properties (e.g., hardness, brittleness, elasticity, density, etc.) which can require different fluid pressure levels and/or different fluid flow characteristics (e.g., pulsed flow, variable flow, constant flow, etc.) to properly cut and/or break the material passing through one or more openings in the die plate and/or extruder die insert. As a result, the fluid pressure and/or flow can be used to cut and/or break the material that has been extruded through one or more openings in the die plate and/or extruder/die insert so as to maintain a desired cut length of the cut extruded material. In still another and/or alternative non-limiting embodiment of the invention, an electronic control system is used to control the rate at which the fluid flows from the cutting assembly so as to cut and/or break the material being extruded from one or more die plates and/or extruder/die inserts. In one non-limiting aspect of this embodiment, a manual and/or electronic fluid control valve is used to control the rate at which the fluid flows from the cutting assembly as the material is extruded from one or more die plates and/or extruder/die inserts. As can be appreciated, other or additional control systems can be used to control the fluid flow from the cutting assembly.

In yet another and/or alternative non-limiting aspect of the present invention, the detected pressure prior to one or more of the openings of the die plate and/or extruder/die insert and/or in one or more of the openings of the die plate and/or extruder/die insert, can also or alternatively be used to set off alarms (i.e., used to indicate one or more operations of the extruder not operating within one or more parameters, etc.) and/or shut down one or more components of the extruder system so as to reduce or prevent damage to one or more components of the extruder system; however, this is not required. In one non-limiting embodiment of the invention, the one or more pressure sensors generate a signal that can be used to activate an alarm to indicate that the detected pressure is below and/or above a desired value. This alarm can be used to detect and/or notify an operator of clogged die openings, worn components (e.g., worn/damaged auger blade, worn/damaged wiper blade, worn/damaged die plate, worn/damaged die/extruder insert, worn/damaged die pins, damaged/malfunctioning pressure sensors, etc.), insufficient feeding of material to be extruded, etc. In another and/or alternative embodiment of the invention, the improved cutting assembly can include a storage system that stores data regarding, but not limited to, a) the detected pressures over a period of time, b) the flow pressure by the cutting assembly, c) the fluid flowrate by the cutting assembly, d) the change out frequency of extruder components (e.g., wiper blade, auger blade, die plate, extruder/die insert, die pins, etc.), e) speed of rotation of the auger blade, f) the type/size of components used in the extruder, g) the type of feed material, h) the rate of material fed to the auger blade, i) the type of fluid used by the cutting assembly, j) the average size of the cut and/or broken extrudate, and/or k) the change out frequency of the cutting assembly components. As can be appreciated, other or additional information can be recorded by the cutting assembly. This data can be used to facilitate in determining whether one or more components of the extruder and/or cutting assembly were operating properly during an extrusion process. The data can also or alternatively be used to control the operation of the cutting assembly. The data can be tagged to a time and/or date period; however, this is not required. This data can be designed to be accessed at real time and/or in other manners. The collected data can be used to activate one or more alarms to indicate an existing or potential problem with one or more components of the extruder and/or cutting assembly; however, this is not required. The collected data can be used to activate one or more alarms to indicate that a component change out is due for one or more components of the extruder and/or cutting assembly; however, this is not required. The collected data can be used to profile the operation of one or more components of the extruder and/or cutting assembly; however, this is not required.

In still yet another and/or alternative non-limiting embodiment of the invention, the improved cutting assembly includes one or more sensors other than a pressure sensor that can be used to affect the fluid pressure and/or the fluid flowrate of the cutting assembly and/or activate one or more alarms; however, this is not required. Such other sensors can include, but are not limited to, temperature sensors, flow sensors, composition sensors, auger rotation speed indicators, fluid pressure of the cutting assembly, fluid flowrate of the cutting assembly, die opening plug detectors, product quality detectors, die plate pressure detectors, product length detectors, etc. These one or more sensors can be located in one or more openings in the die plate and/or extruder/die insert, and/or spaced from one or more openings in the die plate and/or extruder die insert and/or be part of the cutting assembly. The data from one or more of these sensors can be recorded; however, this is not required. The data can be tagged to a time and/or date period; however, this is not required. The data from one or more of the sensors can also or alternatively be used to control the operation of one or more components of the cutting assembly (e.g., fluid pressure, fluid flowrate, etc.) and/or one or more components of the extruder (e.g., auger rotation speed, material feedrate into auger, etc.). The collected data can be also or alternatively be used to activate one or more alarms to indicate that a component change out is due for one or more components of the extruder, and/or the cutting assembly and/or one or more components of the extruder are not working properly; however, this is not required. The collected data can be used to profile the operation of one or more components of the extruder and/or cutting assembly; however, this is not required. In another and/or alternative embodiment of the invention, additional data can be used by the cutting assembly to monitor and/or control one or more components of the extruder and/or cutting assembly. Such data can include, but is not limited to, die plate size, die plate opening configuration, die plate opening size, material of the die plate, thickness of the die plate, die/extruder insert size, die/extruder insert shape, die/extruder insert thickness, die/extruder insert material, type of insert pins, shape of insert pins, material of pins, type of auger blade, material of auger blade, shape of auger blade, size of auger blade, type of feed material, cutting assembly diffuser, type of fluid used by the cutting assembly, flowrate of fluid from and/or to the cutting assembly, fluid pressure from and/or to the cutting assembly, type and/or size of spacer used by the cutting assembly, number of blades on wiper blade, type of wiper blade, spacing of wiper blade from die plate and/or die/extruder insert, wiper blade material, recommended change-out/maintenance for one or more components of the extruder and/or cutting system, recommended operational parameters of one or more components of the extruder and/or cutting system, quality of extruded product, time of usage of one or more components of the extruder and/or cutting system, etc. As can be appreciated, other or additional data can be collected, stored, proceeded, monitored and/or other uses by the cutting assembly. As can also be appreciated, the data that is collected, stored, processed, etc. by the cutting assembly can be used to optimize the operation of the extruder system to produce a higher quality of extruded material. As can be appreciated, any data that can be collected, stored, proceeded, monitored and/or other uses by the cutting assembly can be made available to an operator onsite so that the operator can monitor and/or control one or more operations of the extruder and/or cutting assembly. As can further be appreciated, any data that can be collected, stored, proceeded, monitored and/or other uses by the cutting assembly can also be transmitted to a remote location (e.g., control and/or monitoring station, etc.) so that an operator can monitor and/or control one or more operations of the extruder and/or cutting assembly at a remote location.

In a further and/or alternative non-limiting embodiment of the invention, the improved cutting assembly includes a diffuser that is designed to direct fluid at some angle relative to the plane at which material is being extruded through one or more openings in the die plate and/or extruder/die insert. In one non-limiting embodiment of the invention, the diffuser directs fluid at about 1-90° relative to the plane at which material is being extruded through one or more openings in the die plate and or extruder/die insert. In one non-limiting aspect of this embodiment, the diffuser directs fluid at about 10-90° relative to the plane at which material is being extruded through one or more openings in the die plate and/or extruder/die insert. In another and/or alternative non-limiting aspect of this embodiment, the diffuser directs fluid at about 25-90° relative to the plane at which material is being extruded through one or more openings in the die plate and/or extruder/die insert. In still another and/or alternative non-limiting aspect of this embodiment, the diffuser directs fluid at about 45-90° relative to the plane at which material is being extruded through one or more openings in the die plate and/or extruder/die insert. In another and/or alternative non-limiting embodiment of the invention, the diffuser includes one or more openings that are used to direct fluid at the material as it is being extruded through one or more openings in the die plate and/or extruder/die insert. In one non-limiting aspect of this embodiment, the size of the two or more openings in the diffuser used to direct fluid at the material as it is being extruded through one or more openings in the die plate and/or extruder/die insert can be the same or different. In still another and/or alternative non-limiting aspect of this embodiment, the shape of the two or more openings in the diffuser used to direct fluid at the material is being extruded through one or more openings in the die plate and/or extruder/die insert can be the same or different. In yet another and/or alternative non-limiting aspect of this embodiment, the shape of one or more openings in the diffuser used to direct fluid at the material as it is being extruded through one or more openings in the die plate and/or extruder/die insert can be selected to create a desired fluid flowrate and/or flow profile as the fluid flows through the one or more openings and toward the material as it is being extruded through one or more openings in the die plate and/or extruder/die insert; however, this is not required. In still yet another and/or alternative non-limiting aspect of this embodiment, the number of openings in the diffuser used to direct fluid at the material as it is being extruded through one or more openings in the die plate and/or extruder/die insert is generally at least the same or greater than the number of openings in the die plate and/or extruder/die insert; however, this is not required. In another and/or alternative non-limiting embodiment of the invention, the diffuser can include one or more angled surfaces to cause fluid flowing from the diffuser to contact material that is being extruded through one or more openings in the die plate and/or extruder/die insert at a predefined angle so as to facilitate in the breaking and or cutting of the material from the die plate and/or extruder die insert.

In still another and/or alternative non-limiting embodiment of the invention, the diffuser of the cutting assembly includes one or more inlet openings designed to receive fluid from a pressurized fluid source. The opening can include a connector (e.g., quick connector, threaded connector, etc.) to connect a pressure hose to the opening; however, this is not required.

In still yet another and/or alternative non-limiting embodiment of the invention, the cutting assembly directs high pressure fluid at some point that is spaced from the point that the material is extruded through one or more openings in the die plate and/or extruder/die insert; however, this is not required. This spaced application of high pressure fluid allows material to be extruded at some distance out from the one or more openings in the die plate and/or extruder/die insert prior to encountering the high pressure fluid from the cutting assembly. The control of the space results in controlling the length of the cut and/or broken extruded material. In one non-limiting embodiment of the invention, one or more spacers can be used to direct high pressure fluid at some point that is spaced from the point that the material is extruded through one or more openings in the die plate and/or extruder/die insert; however, it can be appreciated that other or additional arrangements (e.g., die plate designed, diffuser design, etc.) can be used to direct high pressure fluid at some point that is spaced from the point that the material is extruded through one or more openings in the die plate and/or extruder/die insert. Many different distances at which high pressure fluid is directed at some spaced point from the point that the material is extruded through one or more openings in the die plate and/or extruder/die insert can be selected. In one non-limiting design, the distance at which high pressure fluid is directed at some spaced point from the point that the material is extruded through one or more openings in the die plate and/or extruder/die is generally about 0-5 inches. In another non-limiting design, the distance at which high pressure fluid is directed at some spaced point from the point that the material is extruded through one or more openings in the die plate and/or extruder/die is generally about 0-2 inches. In still another non-limiting design, the distance at which high pressure fluid is directed at some spaced point from the point that the material is extruded through one or more openings in the die plate and/or extruder/die is generally about 0-1 inches. As can be appreciated; other distances can be used.

In another and/or alternative non-limiting embodiment of the invention, there is provided a specially designed die plate that is used in association with the cutting assembly of the present invention, which die plate enables the cutting assembly to be connected to the die plate in close proximity to the material being extruded through one or more openings in the die plate and/or extruder/die.

In still another and/or alternative non-limiting embodiment of the invention, the cutting assembly can include one or more operational modes; however, this is not required. In one non-limiting embodiment of the invention, one mode of the cutting assembly can be a manual mode wherein the flowrate and/or fluid pressure to the cutting assembly is set and maintained substantially constant throughout an extrusion process. In another and/or alternative non-limiting embodiment of the invention, the cutting assembly can include an automatic mode wherein a) flowrate and/or fluid pressure to the cutting assembly can be controlled, b) flowrate and/or fluid pressure from one or more openings in the diffuser can be controlled, c) the angle at which the high pressure fluid is directed at the material being extruded through one or more openings in the die plate and/or extruder/die insert, and/or d) the amount of space that high pressure fluid is directed from the point that the material is extruded through one or more openings in the die plate and/or extruder/die insert can be controlled. The control of the cutting assembly in the automatic mode can be based on one or more set and/or detected parameters (e.g., current weather conditions, time of day, time of year, geographic location, type of extruder, extruder configuration, type of feeder for extruder, die plate temperature, auger blade temperature, material to be extruded temperature, material to be extruded flowrate, material to be extruded composition, material to be extruded density, time period required for material to move through one or more openings in die plate and/or die/extruder insert, time period required for material to move along auger blade at a certain auger blade rotation speed, auger blade rotation speed, die plate and/or die/extruder insert opening plug detection, product quality detection, die plate pressure detection, pressure in one or more openings of die plate and/or die/extruder insert, temperature in one or more openings of die plate and/or die/extruder insert, time of use for die/extruder inserts, time of use for die plate, time of use for die pins, time of use for auger blade, time of use for liner, type of liner, material of liner, shape of liner, die plate size, die plate opening configuration, die plate opening size, material of the die plate, thickness of the die plate, die/extruder insert size, die/extruder insert shape, die/extruder insert thickness, die/extruder insert material, die extruder insert hole profile, type of insert pins, shape of insert pins, material of insert pins, type of auger blade, material of auger blade, size/shape of auger blade, type of feed material, type of high pressure fluid from the cutting assembly, flowrate of high pressure fluid from the cutting assembly, flow profile of high pressure fluid from the cutting assembly, type of diffuser of the cutting assembly, the spacing of the high pressure fluid from the point that the material is extruded through one or more openings in the die plate and/or extruder die insert, the angle at which the high pressure fluid is directed to the material being extruded through one or more openings in the die plate and/or extruder/die insert, number of blades on wiper blade, type of wiper blade, spacing of wiper blade from die plate and/or die/extruder insert, wiper blade material, calculated and/or detected wear rates and/or information of one or more components of the extruder and/or cutting assembly, etc.) so as to obtain the desired cut material length and/or product quality of the extruded and cut material. As mentioned above, one or more of these parameters can be recorded by the cutting assembly and/or one or more other components of the extruder, manually and/or automatically input into the cutting assembly and/or one or more other components of the extruder, and/or transmitted to and/or received from a remote location.

In still yet another and/or alternative non-limiting embodiment of the invention, the improved cutting assembly can include one or more detectors (e.g., camera [video camera, standard camera, etc.], light sensor, radio frequency sensor, sound wave sensor, electromagnetic wave sensor for non-visible electromagnetic waves [X-rays, infrared light, ultraviolet light, gamma waves, etc.], etc.) to monitor the length of the extruded material prior to, during, and/or after the cutting process. This monitored information can be used to provide data on the quality of the material being cut, the percentage of the material being cut that is within an acceptable length, and/or to control the fluid flowrate and/or fluid pressure through the cutting assembly to better obtain a desired cut length of the material. As can be appreciated, the detection of the length of the cut material can be monitored at the location of the cutting assembly and/or at some period after the material has been cut (e.g., when the cut material is being conveyed to a drying location, etc.). In one non-limiting embodiment of the invention, a video monitor or other device can be used to monitor the material being cut and/or conveyed and a software program or other type of statistical device can be used to determine the length of the cut product, and then send such information to one or more controllers (e.g., pressure and/or flowrate controller, etc.) to be used to adjust the fluid flowrate and/or fluid pressure from the cutting assembly based upon the determined length for the cut product and/or provide quality control data regarding the cut product. As can be appreciated, other or additional control systems can be used. In another and/or alternative non-limiting embodiment of the invention, a closed loop system could be used to further simplify the control system (e.g., reduce the number of control switches an operator uses) and/or facilitate in obtaining the desired product quality.

In a further and/or alternative non-limiting embodiment of the invention, the cutting assembly can be ergonomically designed so as to facilitate in the operation of the cutting assembly and/or to facilitate in the repair and maintenance of the cutting assembly. In one non-limiting embodiment of the invention, the cutting assembly allows the operator to easily access various connectors, bolts, switches, etc. which are required for periodic operation and/or maintenance of the cutting assembly. As a result of this ergonomic design, the need for special tools is reduced or eliminated and/or the operation and/or maintenance of the cutting assembly is simplified, thereby reducing the time and/or cost of maintenance and repair.

One non-limiting object of the present invention is the provision of a method and process for forming more uniform cut lengths of an extruded product.

Another and/or alternative non-limiting object of the present invention is the provision of a method and process for a cutting assembly that can be used to improve the forming of more uniform cut lengths of an extruded product.

Still another and/or alternative non-limiting object of the present invention is the provision of a method and process for a cutting assembly that uses high pressure fluid to cut lengths of an extruded product.

These and other advantages will become apparent to those skilled in the art upon the reading and following of this description taken together with the accompanying drawings.

### BRIEF DESCRIPTION OF THE FIGURES

Reference may now be made to the drawings, which illustrate various embodiments that the invention may take in physical form and in certain parts and arrangements of parts wherein:

FIG. 1 is a side cross-sectional view of an exploded view of the cutting assembly and die holder according to one non-limiting embodiment of the present invention;

FIG. 2 is a side cross-section view of the cutting assembly, die holder and die plate shown in FIG. 1;

FIGS. 3-5 are several non-limiting configurations of a diffuser for cutting in accordance with the present invention;

FIG. 6 illustrates one non-limiting configurations of a manifold for cutting in accordance with the present invention;

FIG. 7 illustrates one non-limiting configuration of a spacer disk for cutting in accordance with the present invention;

FIG. 8 is a side cross-sectional view of an exploded view of another non-limiting cutting assembly and die holder according to the present invention;

FIG. 9 is a side cross-section view of the cutting assembly, die holder and die plate shown in FIG. 8;

FIG. 10 is a side cross-sectional view of an exploded view of another non-limiting cutting assembly and die holder according to the present invention;

FIG. 11 is a side cross-section view of the cutting assembly, die holder and die plate shown in FIG. 10;

FIG. 12 illustrates another non-limiting configurations of a spacer disk for cutting in accordance with the present invention; and,

FIG. 13 is a top view of a non-limiting die plate.

### DETAILED DESCRIPTION OF THE INVENTION

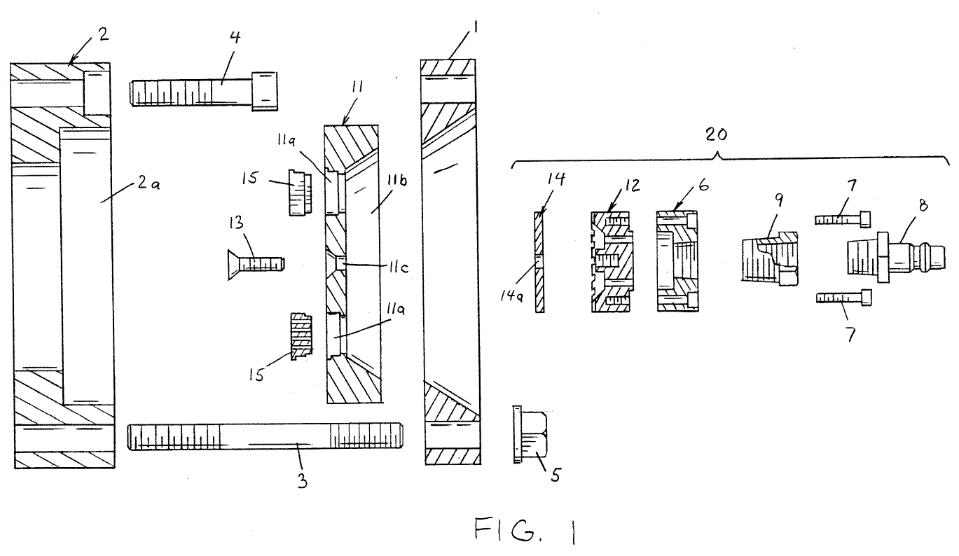

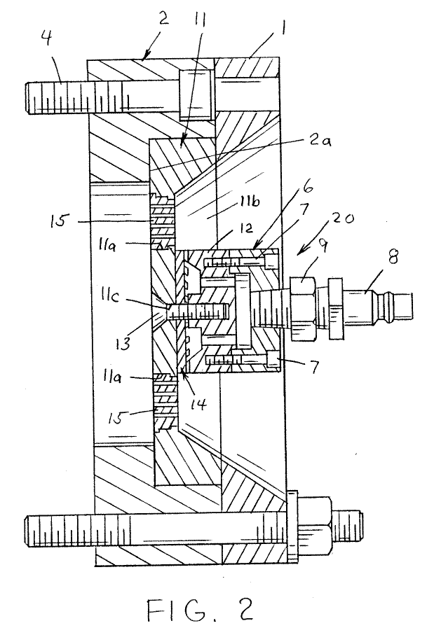

Referring now to the drawings wherein the showing is for the purpose of illustrating preferred embodiments of the invention only and not for the purpose of limiting the same, FIGS. 1 and 2 illustrate non-limiting configurations of a portion of an extruder system and the cutting assembly in accordance with the present invention. Specifically, FIG. 1 illustrates a cross-section view of a die holder 2, that is designed to receive a cutting assembly 20, which cutting assembly is designed to be secured to a die plate 11. Die holder 2 can be connected to the head of any type of extruder by use of one or more screws 4 as illustrated in FIG. 2. As can be appreciated, the die holder can be connected to the extruder in other or additional arrangements. Die plate 11 is designed to fit into a cavity 2a in die holder 2. This is best illustrated in FIG. 2. A clamping ring 1 is designed to be secured to the die holder by one or more threaded studs 3 and bolts 5 as illustrated in FIGS. 1 and 2. As can be appreciated, the clamping ring can be designed to be secured to the die holder by other or additional arrangements. The clamping ring is used to secure the die plate in the cavity of the die holder.

Die plate 11 includes at least one die insert cavity 11a when extruder/die inserts are used with the die plate. The extruder/die inserts can have many different cross-sectional shapes (e.g., diamond shaped, triangular shaped, circular shaped, etc.). The extruder die inserts typically have one or more openings through the extruder die insert that are used to form the shape of the material being extruded through the die plate. Pins can also be inserted in one or more openings in the extruder/die inserts to create the shape of the material being extruded through the die plate. The extruder/die inserts are typically formed of a polymer material; however, other or additional materials can be used (e.g., metal, ceramic, etc.). The die plate and clamping ring are typically formed of a metal material; however, other materials can be used.

Die plate 11 also includes a front cavity 11b. The cavity 11b has sloped sides that align with the sloped sides of the clamping ring as illustrated in FIG. 2. As can be appreciated, the die plate does not require sloped sides and/or sloped sides that align with any side of the clamping ring. The middle of the die plate includes an opening 11c that is designed to enable a screw 13 to be secured to a portion of the cutting assembly 20 as will be described in more detail below. The die plate 11 is designed in one non-limiting arrangement to have a front cavity 11b that has a depth such that the bottom surface of the front cavity is closely or substantially flush with an end of an extruder/die insert when an extruder/die insert is inserted in the die plate as illustrated in FIG. 2. As can be appreciated, this configuration of the die plate is not required. As will be described in more detail below, the material being extruded through the extruder/die inserts has a tendency to break off at the location where the material exits the extruder/die inserts. As such, when a force such as a high pressure fluid is applied to the material being extruded, the high pressure fluid facilitates in causing the extruded material to be cut or break off from the extruder die insert. By adjusting the location at which the high pressure fluid contacts the extruded material, the size of the cut or broken extruded material can be controlled.

In general, the extruder system includes an auger blade, not shown, or other or additional device that is designed to move material, not shown, to be extruded toward the die plate 1. The die plate 11 generally has a plurality of openings 11a that are each designed to receive a die/extruder insert 15. The material that is transported by the auger blade is designed to become an extruded product such as, but not limited to, a catalyst. As can be appreciated, the present invention can be used to form many types of products other than catalyst. Although not shown, the opposite end of the auger blade is connected to a motor that is designed to rotate the auger blade. The use of such a motor, and the configuration of the motor and the necessary connection between the motor and auger blade are well known in the art, thus will not be further described. Also not shown is the feed section for the auger blade that feeds material to the auger blade, which in turn transports the material to the die plate. Many different auger blade feed arrangements can be used, and many of these feed arrangements are well known in the art and will not be further described.

The auger blade that is used in the extruder system can have many different configurations. Two non-limiting configurations for the auger blade are a single flight configuration or a dual flight configuration. The front end of the auger blade can include a connection arrangement that is designed to secure a wiper blade to the front end of the auger blade; however, this is not required. When a wiper blade is not to be connected to the front end of the auger blade, the connection arrangement can be eliminated. The connection arrangement can be designed in many different ways to facilitate in the connection of a wiper blade to the front end of the auger. In one non-limiting arrangement, the connection arrangement can include a cavity and a threaded opening. The auger blade, when used, is typically housed in an auger housing or liner, not shown, that defines a generally cylindrical opening through which the material to be extruded travels. As can be appreciated, other housing or liner shapes can be used. The use of an auger housing or liner in conjunction with an auger blade for various types of extruder applications is well known in the art, thus will not be further described.

Die plate 11 is a generally circular plate having a plurality of insert openings 11a that are formed in the die plate. As can be appreciated, the die plate need not be circular (e.g., oval, polygonal, etc.). The insert openings 11a in the die plate can have a variety of configurations and/or shapes. The insert opening can have a generally triangular shape or diamond shape. As can be appreciated, other or additional insert shapes can be used (e.g., oval, circular, square, pentagonal, hexagonal, rectangular, rhombus shaped, trapezoidal, etc.). The size and shape of the insert openings on each die plate is generally the same, however, this is not required. As such, a die plate can have different sized openings and/or different shaped openings on the die plate. Many different configurations of openings for the inserts can be used. As such, many opening configurations and/or numbers of opening can be used on the die plates. The extruder die inserts can also have a variety of interior configurations, not shown, to facilitate in receiving certain shaped die/extruder inserts. The die plates can also include one or more mount holes that are designed to receive a bolt and/or other type of connector to facilitate in mounting the die plate to the extruder system; however, this is not required. The front and/or back face of the die plate can have one or more recessed portions; however, this is not required. The die plates can include one or more orientation structures that are designed to facilitate in the proper placement of the die/extruder insert into the die opening; however, this is not required.

Referring again to FIGS. 1 and 2, the cutting assembly 20 is designed to use a fluid such as air to cut or break material that is extruded through the extruder/die inserts 15. The cutting assembly includes a hose coupler 8 that is designed to connect to a fluid supply hose such as an air hose. The hose coupler can include a quick disconnect coupler for the fluid hose; however, this is not required. The cutting assembly can include a reducer bushing 9 that is designed to be connected to the hose coupler; however, the reducer bushing is not required. As illustrated in FIG. 1, the reducer cavity includes a threaded internal cavity that is designed to receive a portion of the hose coupler. As can be appreciated, when the reducer bushing is used, the hose coupler can be connected to the reducer coupler by other or additional arrangements. The reducer bushing is illustrated as having an outer threaded surface that is designed to be connected to a cavity in manifold 6. The manifold is not required. As can be appreciated, when the reducer bushing is used, the reducer bushing can be connected to the manifold by other or additional arrangements. As can also be appreciated, when the reducer bushing is not used, the hose coupler can be connected to the manifold 6 or diffuser 12 by many different arrangements. Manifold 6, when used, can include one or more connection openings that are designed to receive one or more screws 7 so as to secure the flange nut to diffuser 12. As can be appreciated, when the manifold is used, the manifold can be connected to the diffuser by other or additional arrangements.

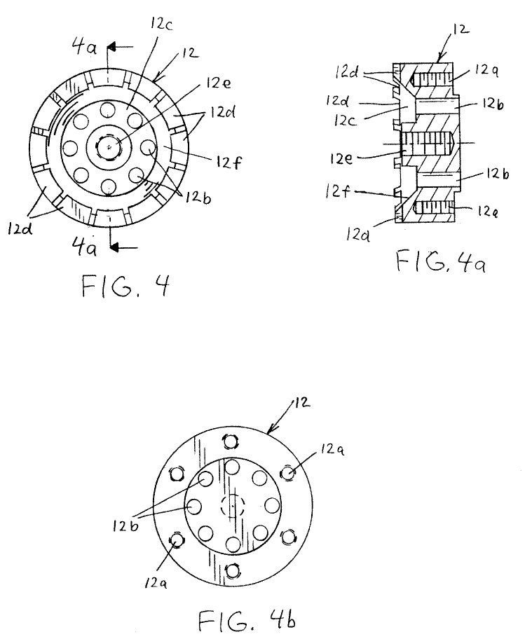

Referring now to FIGS. 6, 6a and 6b, one non-limiting configuration for manifold 6 is illustrated. Manifold 6 includes a central cavity 6a that has a generally circular shape; however, other shapes can be used. Manifold 6 also includes a plurality of attachment openings 6b that are designed to receive screws 7 so that the manifold can be secured to diffuser 12. FIG. 6a illustrates a top view of manifold 6, FIG. 6b illustrates a side view of manifold 6, and FIG. 6 illustrates a cross-sectional side view of manifold 6. Central cavity 6a is illustrated as having a reducing diameter along the longitudinal length of the cavity; however, this is not required. Each of attachment openings 6b have a larger top opening to seat the head of screw 7; however, this is not required.

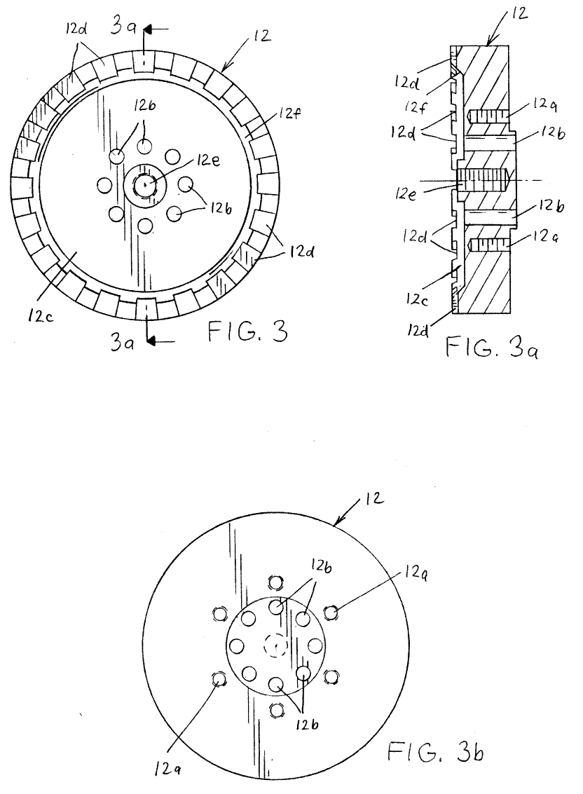

As illustrated in FIGS. 1 and 2, the hose coupler 8, reducing bushing 9, when used, and manifold 6, when used, are designed to direct fluid from a fluid hose, not shown, to diffuser 12. Diffuser 12 is designed to direct fluid so as to contact material that is being extruded through the extruder/die inserts 15 so as to cause the extruded material to be cut or broken. Referring now to FIGS. 3-4, two non-limiting diffusers are illustrated. Both of the diffusers are illustrated in FIGS. 3a, 4a as having a front face that includes a plurality of threaded connection holes 12a that are designed to receive the end of screw 7 so as to secure the manifold 6 to the diffuser; however, these holes are not required. All of the diffusers are also illustrated in FIGS. 3, 4 as having a front face that includes a plurality of fluid openings 12b that are designed to direct fluid through the diffuser. As can be appreciated, the diffuser can include only one fluid opening or a different number of fluid openings as illustrated in FIGS. 3-4. The fluid openings can be spaced from one another in a uniform or non-uniform manner. As illustrated in FIGS. 3 and 4, the fluid openings are spaced from one another in a uniform manner about the center of the diffuser. The size and/or shape of the fluid openings can be the same or different. As illustrated in FIGS. 3 and 4, the shape of the fluid openings are circular; however, other shapes can be used. As also illustrated in FIGS. 3 and 4, the size of the fluid openings are generally the same. The back face of the diffuser includes a recessed central region 12c and a plurality of edge recesses 12d. The recess depth of the edge recesses 12d are illustrated as being less than the depth of the central region 12c. The depth of central region 12c can be large as illustrated in FIG. 4a (e.g., 25% and greater of the total thickness of diffuser), or shallow as illustrated in FIG. 3a (e.g., less than 25% of the total thickness of diffuser). As illustrated in FIGS. 3-4, the diffuser can have many different number of edge recesses 12d. The edge recesses can be spaced from one another in a uniform or non-uniform manner. As illustrated in FIG. 3, the edge recesses are spaced at about 8-15° (e.g., 10°) apart from one another about the outer perimeter of the diffuser. As illustrated in FIG. 4, the edge recesses are spaced at about 18-30° (e.g., 25°) apart from one another about the outer perimeter of the diffuser. There can also be a sloped transition between central cavity 12c and the edge recess 12d; however, this is not required. As illustrated in FIGS. 3a, 4a. a sloped surface 2f provides for a transition between central cavity 12c and the edge recess 12d. The length of an angle of sloped surface 12f is non-limiting. As illustrated in FIGS. 3a, 4a, the angle of slope of sloped surface 12f is about 15-70° (e.g., 45°). The back face of the diffuser also includes a connection opening 12e that is designed to secure the diffuser 12 to the die plate 11 via screw 13. The connection opening 12e is shown so as to not fully penetrate the full thickness of the diffuser; however, connection opening 12e can be designed to fully penetrate the diffuser. As can be appreciated, the diffuser can be connected to die plate 11 by other or additional arrangements.

Referring now to FIG. 5, an alternative non-limiting configuration for a diffuser 12 is illustrated. The configuration of diffuser 12 is generally the same as the diffuser in FIGS. 3-4, thus most of the components of the diffuser of FIG. 5 will not be repeated again. The transition region from the central region to the edge region can have a sloped surface 12f; however, this is not required. As illustrated in FIG. 5a, the sloped angle of the sloped surface 12f is about 45°; however, it can be appreciated that the sloped angle can be from about 1-89°, and generally about 5-75°, and more generally about 20-60°. As also illustrated in FIG. 5a, the outer edge 12g of the edge recess 12d also has a sloped angle; however, this is not required. As illustrated in FIG. 5a, the sloped angle of the sloped angle of the outer edge is about 35°; however, it can be appreciated that the sloped angle can be from about 1-89°, and generally about 5-75°, and more generally about 20-60°. Generally, the angle of slope for the outer edge is less than the angle of slope for sloped surface 12f; however, this is not required. The sloped angles from both the outer edge 12g and the sloped surface 12f can be used to facilitate in the cutting and/or breaking of the extruded material as the material is extruded from the die plate. As can be appreciated, sloped outer edges can be used without the use of a sloped surface 12f. Likewise, a sloped surface 12f can be used without a sloped outer edge. As can also be appreciated, the sloped surface need not be flat or planar as illustrated in FIGS. 3 and 4. For instance, one or more portions of the sloped surface can be curved and/or have some other shape. The fluid openings 12b are designed to direct fluid to central region 12c wherein the fluid disperses generally evenly about the central region and toward the edge recesses 12d. When the diffuser is secured to the face of the die place as illustrated in FIG. 2, the fluid that flows into the central region of the diffuser can substantially only exit via the edge recesses 12d. The side of the gap that is formed between the face of the die plate and the edge recess can be selected to control the velocity and/or direction of fluid flowing through the gap. The shape of the edge recess can also or alternatively be used to control the flow pattern, direction and/or velocity of the fluid flow through the gap. As illustrated in FIG. 2, the direction of flow of fluid through the gap is substantially normal (90°) to the plane at which material is extruded through the extruder/die inserts. As can be appreciated, the direction of flow of fluid through the gap can be other than substantially normal (90°) to the plane at which material is extruded through the extruder/die inserts. The number of gaps formed by the diffuser is generally selected to form a sufficient fluid flow pattern over the die plate so as to cause the material that is extruded through the extruder/die inserts to be cut and/or broken when contacted by the flowing fluid.

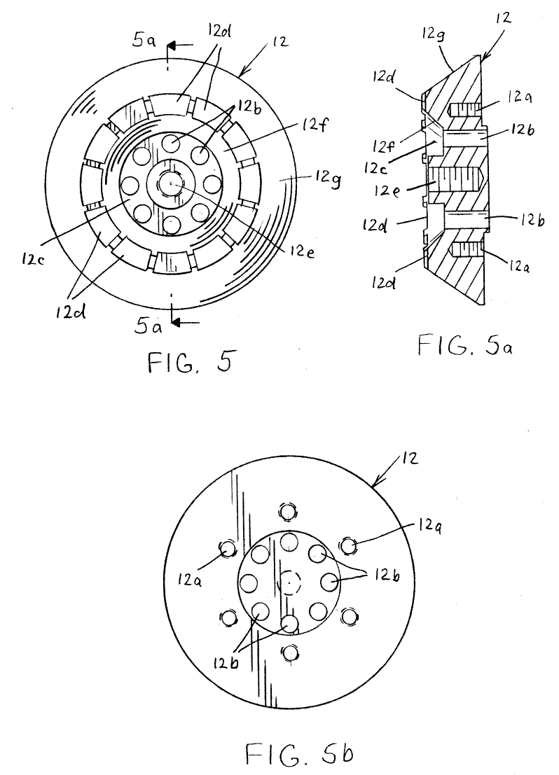

One or more spacer disks 14 can be used to control the length of extruded material that is cut or broken by the fluid flow from the diffuser. FIG. 7 illustrates one non-limiting design and thickness of a spacer disk. As can be appreciated, other designs and/or thickness of spacer disks can be used. The spacer disk, when used, is used to delay the time that the fluid flowing from the gaps formed by the diffuser contacts the material being extruded from the extruder/die inserts. As such, the spacers disk is at least partially used to control the length of extruded material that is cut or broken by the fluid flowing through the gaps formed by the diffuser. Generally, the extruded material, when contacted by the fluid flow breaks at the location near the face of the die plate. As such a constant fluid flow can be used to break or cut generally uniform pieces of extruded material. The spacer disk can be made of a variety of materials (e.g., metal, plastic, wood, ceramic, etc.) The shape of the spacer disk is generally circular; however, this is not required. The spacer disk has a central opening 14a that passes through the spacer disk. The central opening is designed to enable screw 13 to pass through the spacer disk when connecting the cutting assembly to a die plate and/or die holder.

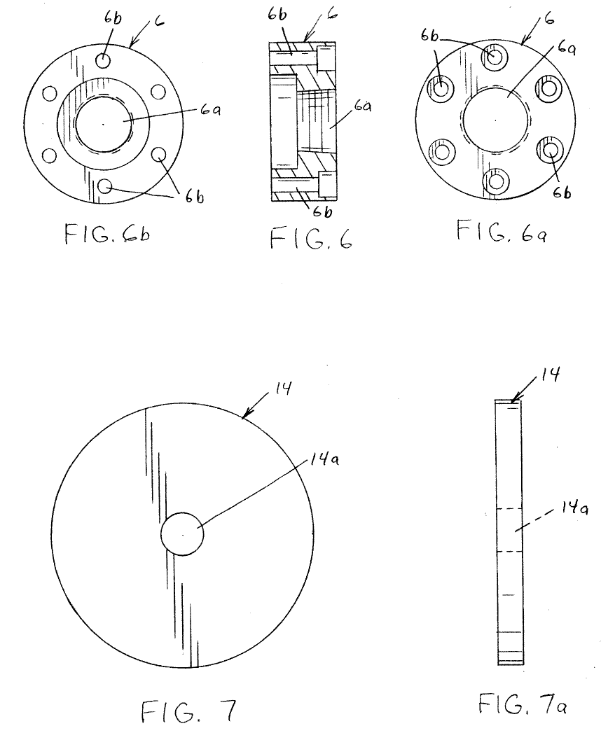

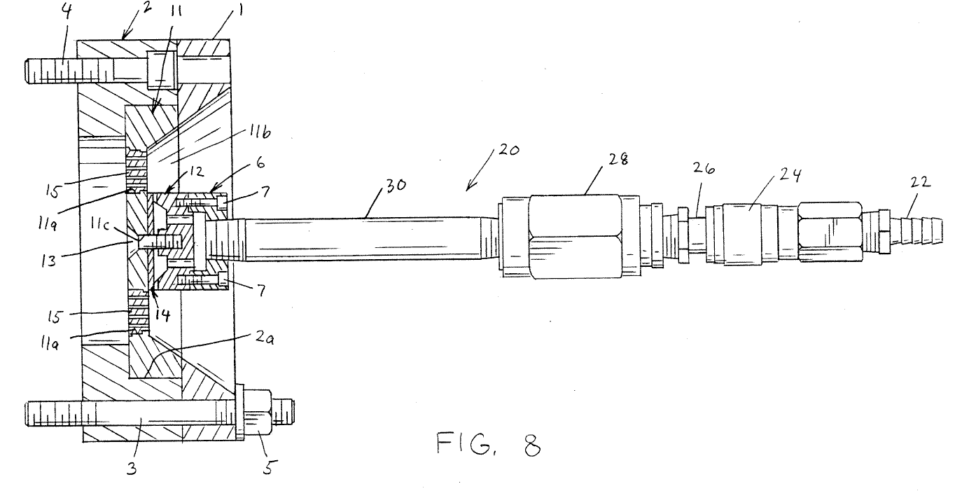

Referring now to FIGS. 8 and 9, there is illustrated another non-limiting configuration of a portion of an extruder system and the cutting assembly in accordance with the present invention. FIG. 9 illustrates a cross-section view of a die holder 2, that is designed to receive a cutting assembly 20, which cutting assembly is designed to be secured to a die plate 11. Die holder 2 can be connected to the head of any type of extruder by use of one or more screws 4 as illustrated in FIGS. 8 and 9. As can be appreciated, the die holder can be connected to the extruder in other or additional arrangements. Die plate 11 is designed to fit into a cavity 2a in die holder 2. This is best illustrated in FIG. 8. A clamping ring 1 is designed to be secured to the die holder by one or more threaded studs 3 and bolts 5 as illustrated in FIG. 8. As can be appreciated, the clamping ring can be designed to be secured to the die holder by other or additional arrangements. The clamping ring is used to secure the die plate in the cavity of the die holder.

Die plate 11 includes at least one die insert cavity 11a when extruder/die inserts 15 are used with the die plate. The extruder/die inserts can have many different cross-sectional shapes (e.g., diamond shaped, triangular shaped, circular shaped, etc.). The extruder/die inserts typically have one or more openings through the extruder/die insert that are used to form the shape of the material being extruded through the die plate. Pins can also be inserted in one or more openings in the extruder/die inserts to create the shape of the material being extruded through the die plate. The extruder/die inserts are typically formed of a polymer material; however, other or additional materials can be used (e.g., metal, ceramic, etc.). The die plate and clamping ring are typically formed of a metal material; however, other materials can be used.

Die plate 11 also includes a front cavity 11b. The cavity 11b has sloped sides that align with the sloped sides of the clamping ring as illustrated in FIG. 8. As can be appreciated, the die plate does not require sloped sides and/or sloped sides that align with any side of the clamping ring. The middle of the die plate includes an opening 11c that is designed to enable a screw 13 to be secured to a portion of the cutting assembly 20 as will be described in more detail below. The die plate 11 is designed in one non-limiting arrangement to have a front cavity 11b that has a depth such that the bottom surface of the front cavity is closely or substantially flush with an end of an extruder/die insert when an extruder/die insert is inserted in the die plate as illustrated in FIG. 8. As can be appreciated, this configuration of the die plate is not required. Die plate 11 is a generally circular plate having a plurality of insert openings 11a that are formed in the die plate. As can be appreciated, the die plate need not be circular (e.g., oval, polygonal, etc.). The insert openings 11a in the die plate can have a variety of configurations and/or shapes. The insert openings can have a generally triangular shape or diamond shape. As can be appreciated other or additional insert shapes can be used (e.g., oval, circular, square, pentagonal, hexagonal, rectangular, rhombus shaped, trapezoidal, etc.). The size and shape of the insert openings on each die plate is generally the same; however, this is not required. As such, a die plate can have different sized openings and/or different shaped openings on the die plate. Many different configurations of openings for the inserts 15 can be used. As such, many opening configurations and/or number of openings can be used on the die plates. The extruder/die inserts can also have a variety of interior configurations, not shown, to facilitate in receiving certain shaped die/extruder inserts. The die plates can also include one or more mount holes that are designed to receive a bolt and/or other type of connector to facilitate in mounting the die plate to the extruder system; however, this is not required. The front and/or back face of the die plate can have one or more recessed portions; however, this is not required. The die plates can include one or more orientation structures that are designed to facilitate in the proper placement of the die/extruder insert into die opening; however, this is not required.

Referring again to FIGS. 8 and 9, the cutting assembly 20 is designed to use a fluid such as air to cut or break material that is extruded through the extruder/die inserts 15. The cutting assembly includes a hose coupler 22 that is designed to connect to a fluid supply hose such as an air hose. The hose coupler can include a quick disconnect coupler for the fluid hose; however, this is not required. In the arrangement illustrated in FIGS. 8 and 9, the reducer bushing 9 illustrated in FIGS. 1 and 3 is replaced by several components. As illustrated in FIGS. 8 and 9, hose coupler 22 is connected to a quick release female coupler 24. The quick release female coupler is designed to be releaseably connected to quick release male coupler 26. Quick release male coupler 26 is connected to a flow control valve 28 that can be used to adjust the fluid flow to several of the components of the cutting arrangement. Flow control valve 28 is connected to a pipe 30. As can be appreciated components 22, 24, 26, 28, and 30 are optional components. As illustrated in FIG. 9, pipe 30 has an outer threaded surface that is designed to be connected to a cavity in manifold 6. The manifold is not required. As can be appreciated, when pipe 30 is used, the pipe can be connected to the manifold by other or additional arrangements. As can also be appreciated, when pipe 30 is not used, the hose coupler can be connected to the manifold 6 by many different arrangements. Manifold 6, when used, can include one or more connection openings 6a that are designed to receive one or more screws 7 so as to secure the manifold to diffuser 12. As can be appreciated, when the manifold is used, the manifold can be connected to the diffuser by other or additional arrangements. Several non-limiting configurations of manifolds that can be used are illustrated in FIGS. 6, 6a and 6b. FIGS. 3-5 also illustrate two non-limiting diffusers that can be used. The function of the manifold and diffuser in the cutting arrangement has been previously described above, thus will not be repeated. One or more spacer disks 14 can be used to control the length of extruded material that is cut or broken by the fluid flow from the diffuser. FIG. 7 illustrates one non-limiting design and thickness of a spacer disk that can be used. The function of the spacer disk in the cutting arrangement has been previously described above, thus will not be repeated.

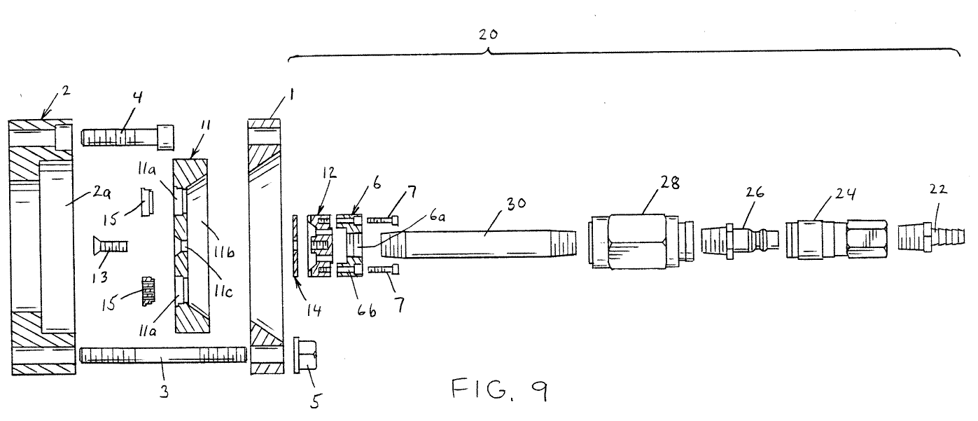

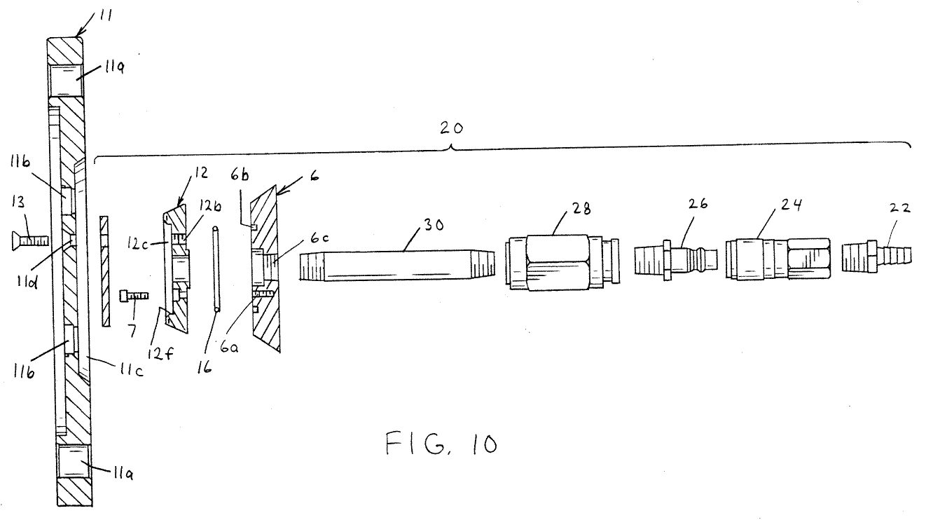

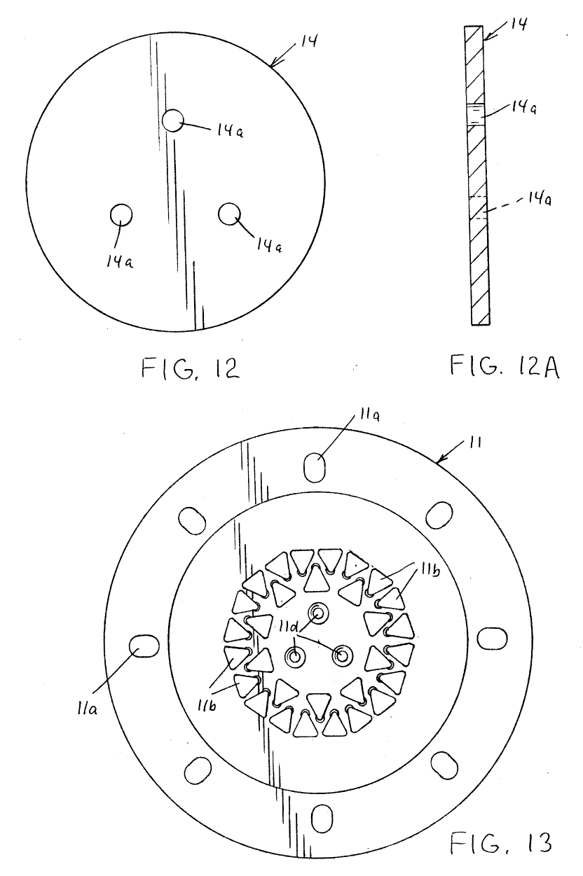

Referring now to FIGS. 10 and 11, there is illustrated another non-limiting configuration of a portion of an extruder system and the cutting assembly in accordance with the present invention. FIG. 10 illustrates a cross-section view of a die plate 11 that is designed to receive a cutting assembly 20. In this arrangement, the cutting assembly is secured to the die plate independently of the die holder, not shown. The die plate 11 is then connected to the die holder by one or more connectors (e.g., bolts, screws, etc.), not shown, as in standard practice. FIG. 13 illustrates one non-limiting die plate 11. The outer region of the die plate includes a plurality of connector openings 11a that are designed to receive a screw, bolt. etc., not shown. As can be appreciated, die plate 11 can be connected to the die holder and/or extruder, not shown, in other or additional arrangements. Die plate 11 is designed to fit into a cavity of a die holder; however, this is not required. A clamping ring, not shown, can be used to secure the die plate to the die holder and/or extruder by one or more threaded studs 3 and bolts 5; however, this is not required.

Die plate 11 includes at least one die insert cavity 11b when extruder/die inserts 15 are used with the die plate. The extruder/die inserts can have many different cross-sectional shapes (e.g., diamond shaped, triangular shaped, circular shaped, etc.). The extruder/die inserts typically have one or more openings through the extruder/die insert that are used to form the shape of the material being extruded through the die plate. Pins can also be inserted in one or more openings in the extruder/die inserts to create the shape of the material being extruded through the die plate. The extruder/die inserts are typically formed of a polymer material; however, other or additional materials can be used (e.g., metal, ceramic, etc.). The die plate and clamping ring are typically formed of a metal material; however, other materials can be used.

Die plate 11 also includes a front cavity 11c. The cavity 111 can have sloped sides that align with the sloped sides of a clamping ring, not shown; however, this is not required. As can also be appreciated, cavity 11 need not have sloped sides. As can also be appreciated, die plate 11 does not need to have a cavity 11c. Positioned about the middle of the die plate are three openings 11d that are designed to enable a screw 13 to be secured to a portion of the cutting assembly 20 as will be described in more detail below. As can be appreciated, the die plate can include a large or smaller number of openings 11d. As can also be appreciated, openings 11d can be positioned on other regions of the die plate. As can be appreciated, the die plate can be connected to the cutting assembly in other or additional manners (e.g., bolt, rivet, etc.). The die plate 11 can be designed in one non-limiting arrangement such that front cavity 11c has a depth such that the bottom surface of the front cavity is closely or substantially flush with an end of an extruder/die insert when an extruder/die insert is inserted in the die plate as illustrated in FIG. 11. As can be appreciated, this configuration of the die plate is not required. Die plate 11 is a generally circular plate having a plurality of insert openings 11b that are formed in the die plate. As can be appreciated, the die plate need not be circular (e.g., oval, polygonal, etc.). The insert openings 11b in the die plate can have a variety of configurations and/or shapes. The insert openings can have a generally triangular shape or diamond shape. As can be appreciated other or additional insert shapes can be used (e.g., oval, circular, square, pentagonal, hexagonal, rectangular, rhombus shaped, trapezoidal, etc.). The size and shape of the insert openings on each die plate is generally the same; however, this is not required. As such, a die plate can have different sized openings and/or different shaped openings on the die plate. Many different configurations of openings for the inserts 15 can be used. As such, many opening configurations and/or numbers of openings can be used on the die plates. The extruder/die inserts can also have a variety of interior configurations, not shown, to facilitate in receiving certain shaped die/extruder inserts. The back face of the die plate can have one or more recessed portions; however, this is not required. The die plates can include one or more orientation structures that are designed to facilitate in the proper placement of the die/extruder insert into die opening; however, this is not required.

Referring again to FIGS. 10 and 11, the cutting assembly 20 is designed to use a fluid such as air to cut or break material that is extruded through the extruder/die inserts 15. The cutting assembly includes a hose coupler 22 that is designed to connect to a fluid supply hose such as an air hose. The hose coupler can include a quick disconnect coupler for the fluid hose; however, this is not required. In the arrangement illustrated in FIGS. 10 and 11, the reducer bushing 9 illustrated in FIGS. 1 and 3 is replaced by several components. As illustrated in FIGS. 10 and 11, hose coupler 22 is connected to a quick release female coupler 24. The quick release female coupler is designed to be releaseably connected to quick release male coupler 26. Quick release male coupler 26 is connected to a flow control valve 28 that can be used to adjust the fluid flow to several of the components of the cutting arrangement. Flow control valve 28 is connected to a pipe 30. As can be appreciated components 22, 24, 26, 28, and 30 are optional components. As illustrated in FIG. 10, pipe 30 has an outer threaded surface that is designed to be connected to a cavity 6c in manifold 6. The manifold is not required. As can be appreciated, when pipe 30 is used, the pipe can be connected to the manifold by other or additional arrangements. As can also be appreciated, when pipe 30 is not used, the hose coupler can be connected to the manifold 6 by many different arrangements. Cavity 6c is illustrated as having a varying diameter along the longitudinal length of the manifold; however, this is not required. As illustrated in FIGS. 10 and 11, cavity 6c has a sudden increase in diameter; however, it can be appreciated that cavity 6c can include a gradual diameter increase. As can also be appreciated, the cross-sectional shape of one or more portions of cavity 6c can be circular or non-circular. Manifold 6, when used, can include one or more connection openings 6a on the bottom face that are designed to receive one or more screws 7 so as to secure the manifold to diffuser 12. As can be appreciated, when the manifold is used, the manifold can be connected to the diffuser by other or additional arrangements. The bottom face of the manifold can include a seal recess 6b. The seal recess is designed to receive a portion of an o-ring 16. The o-ring, when used, is designed to form a seal between the manifold and the diffuser. Several other non-limiting configuration of manifolds that can be used are illustrated in FIGS. 6, 6a and 6b. Diffuser 12 is illustrated as being connected to manifold 6 in a different manner as illustrated in FIGS. 1, 2, 8 and 9. As can be appreciated, the design of diffuser 12 in FIGS. 10 and 11 can be used in the cutting arrangement of FIGS. 1, 2, 8 and 9. Likewise, the diffusers illustrated in FIGS. 3-5 can be used in the cutting arrangement of FIGS. 10 and 11. The function of manifold 6 and diffuser 12 in the cutting arrangement of FIGS. 10 and 11 is essentially the same as the manifold 6 and diffuser 12 in the cutting arrangement of FIGS. 1. 2, 8 and 9, thus will not be repeated. As illustrated in FIG. 10, cavity 12c of the diffuser includes a non-constant sloped surface 12f. As illustrated in FIGS. 3a and 4a, sloped surface 12f is planar, but sloped surface 12f in FIGS. 10 and 11 includes two different slopes. As can be appreciated, more than two different slopes can be used to form sloped surface 12f.

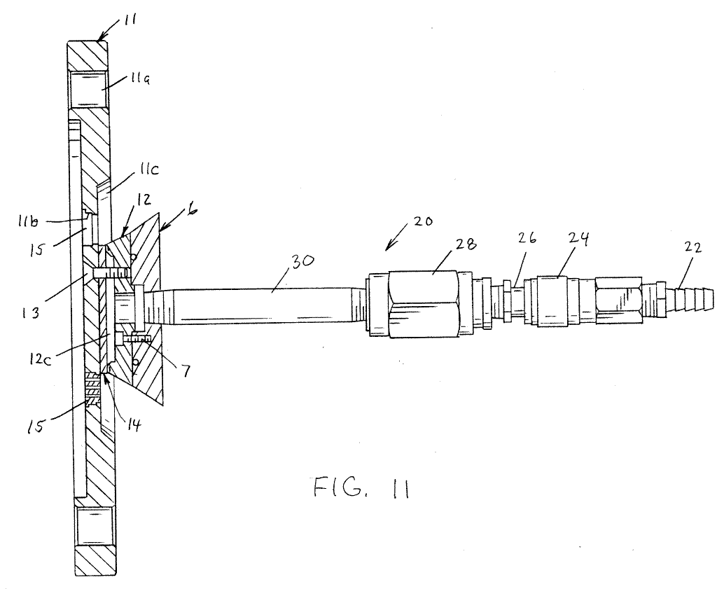

One or more spacer disks 14 can be used to control the length of extruded material that is cut or broken by the fluid flow from the diffuser. FIG. 12 illustrates one non-limiting design and thickness of a spacer disk that can be used. The function of the spacer disk in the cutting arrangement has been previously described above, thus will not be repeated. As illustrated in FIG. 12, three openings 14a are positioned about the center of the spacer disk. The number and orientation of openings 14a on the spacer disk is different from the spacer disk illustrated in FIG. 7. The three holes in the spacer disk are designed to align with the three openings 11d in die plate 11 and the three openings 12b in diffuser 12 so that screw 13 can connect the spacer plate, when used, and the diffuser to the die plate.

As can be appreciated, a flow controller can be used that pulses the flow of fluid to the diffuser so as to facilitate in the cutting or breaking of material at certain lengths that is extruded from the extruder/die inserts; however, this is not required. In such an arrangement, the use of the spacer disk can be eliminated; however, this is not required. Any number of control systems and/or arrangements can be used to pulse the flow of fluid through the diffuser of the cutting assembly. The control systems and/or arrangements can be manually and/or automatically set. The control systems and/or arrangements can be adjusted by feedback control systems and/or other types of control systems; however, this is not required.

High pressure fluid is generally directed to the diffuser. Such pressures generally are about 25-150 psig; however, other pressures can be used.

Although not shown, various types of detectors can be used (e.g., pressure detectors, temperature detectors, vibration detectors, chemical analysis detectors, etc.) can be used to control the quality and consistency of the cut or break length of the extruded material; however, this is not required. For example, one or more pressure transducers can be supplied in the die plate; however, this is not required. The pressure transducers can be designed to communicate with a controller, not shown, which communicates with an auger motor, not shown, fluid flow controller to the diffuser, not shown, etc. If it is detected that the pressure has decreased/increased, various components of the extruder (e.g., rate at which the auger blade rotates, fluid flow and/or pressure to the diffuser, etc.) can be controlled as a function of the detected pressure. As can be appreciated, the controlled parameters can be at least partially controlled by other or additional factors (e.g., current weather conditions, time of day, time of year, geographic location, type of extruder, extruder configuration, type of feeder for extruder, die plate temperature, auger blade temperature, material to be extruded temperature, material to be extruded flowrate, material to be extruded composition, material to be extruded density, time period required for material to move through one or more openings in die plate and/or die/extruder insert, time period required for material to move along auger blade at a certain auger blade rotation speed, auger blade rotation speed, diffuser configuration, die plate and/or die/extruder insert opening plug detection, product quality detection, die plate pressure detection, pressure in one or more openings of die plate and/or die/extruder insert, temperature in one or more openings of die plate and/or die/extruder insert, time of use for die/extruder inserts, time of use for die plate, time of use for die pins, time of use for auger blade, time of use for liner, type of liner, material of liner, shape of liner, die plate size, die plate opening configuration, die plate opening size, material of the die plate, thickness of the die plate, die/extruder insert size, die/extruder insert shape, die/extruder insert thickness, die/extruder insert material, die/extruder insert hole profile, type of insert pins, shape of insert pins, material of insert pins, type of auger blade, material of auger blade, size/shape of auger blade, type of feed material, type of fluid flowing to the diffuser, fluid flow to the diffuser, pressure of fluid to the diffuser, number of blades on wiper blade, type of wiper blade, spacing of wiper blade from die plate and/or die/extruder insert, wiper blade material, calculated and/or detected wear rates and/or information of one or more components of the extruder and/or cutting assembly, etc.).

A sensor arrangement can also be supplied to check the length of the cut or broken extruded material; however, this is not required. For example, the sensor can be in the form of a camera, or the like, that can detect the dimensions of the cut or broken extruded material. The sensor arrangement can be designed to communicate with one or more controllers; however, this is not required. The sensor arrangement can send a signal to the one or more controllers, not shown, in response to the detected dimensions of the cut or broken extruded material. Based at least partially on the detected dimensions of the cut product, operation and/or parameters of various of the extruder and/or cutting assembly can be adjusted to control the length of the cut or broken extruded material.

The cutting assembly can also include a mode control; however, this is not required. The mode control, not shown, can be in communication with one or more controllers, not shown. For instance, the cutting assembly can include an automatic mode wherein the fluid flowrate and/or fluid pressure to the diffuser is adjusted based upon the detection of one or more parameters (e.g., pressure of the material prior to and/or as it is being extruded through the die plate and/or die/extruder insert; the detected velocity of the material prior to, during, and/or after being extruded through the die plate and/or die/extruder insert; detection of the length of the cut material and/or calculating the length of the cut material; current weather conditions; type of extruder; extruder configuration; type of feeder for extruder; die plate temperature; die/extruder insert temperature; auger blade temperature; material to be extruded temperature; material to be extruded flowrate; material to be extruded composition; material to be extruded density; time period required for material to move through one or more openings in die plate and/or die/extruder insert; time period required for material to move along auger blade at a certain auger blade rotation speed; auger blade rotation speed; type of diffuser; type of fluid to diffuser; pressure of fluid to diffuser; die plate and/or die/extruder insert opening plug detection; product quality detection; type of liner; material of liner; shape of liner; die plate size; die plate opening configuration; die plate opening size; material of the die plate; thickness of the die plate; die/extruder insert size; die/extruder insert shape; die/extruder insert thickness; die/extruder insert material; die/extruder insert hole profile; type of auger blade; material of auger blade; size/shape of auger blade; number of blades on wiper blade; type of wiper blade; spacing of wiper blade from die plate and/or die/extruder insert; wiper blade material; vibration detection of one or more components of the extruder; cavitation detection of material to be extruded; detection of amount of material being fed by auger blade; calculated and/or detected wear rates and/or information of one or more components of the extruder and/or cutting assembly, etc.). The cutting assembly can include one or more measured and/or adjustable parameters to adjust the length of the extruded material being cut and/or broken so as to obtain a desired length of the cut material, etc.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

I claim:

1. A cutting assembly for cutting a material extruded from an die plate, the assembly comprising:
a die plate that includes an inner face and a front face;
a feed arrangement designed to feed said material toward said inner face of said die plate to cause said material to at least partially pass through said die plate;
a cutting assembly that includes diffuser, said diffuser design cause pressurized fluid to flow toward said material that has passed through said die plate so as to at least partially cut and/or break said material, said diffuser positioned at least closely adjacent to said front face of said die plate.

2. The cutting assembly as defined in claim 1, wherein said fluid is a gas.

3. The cutting assembly as defined in claim 1, wherein said gas includes air, steam, nitrogen, noble gas, and combinations thereof.

4. The cutting assembly as defined in claim 2, wherein said gas includes air, steam, nitrogen, noble gas, and combinations thereof.

5. The cutting assembly as defined in claim 1, including a disk spacer positioned between said diffuser and said die plate.

6. The cutting assembly as defined in claim 4, including a disk spacer positioned between said diffuser and said die plate.

7. The cutting assembly as defined in claim 1, wherein said die plate includes at least one extruder/die insert opening designed to at least partially receive an extruder/die insert.

8. The cutting assembly as defined in claim 6, wherein said die plate includes at least one extruder die insert opening designed to at least partially receive an extruder die insert.

9. The cutting assembly as defined in claim 1, wherein said diffuser includes at least one sloped surface to at least partially control the direction of fluid exiting said diffuser.

10. The cutting assembly as defined in claim 8, wherein said diffuser includes at least one sloped surface to at least partially control the direction of fluid exiting said diffuser.

11. The cutting assembly as defined in claim 1, including a cutting control system designed to at least partially control a rate of cutting of said material by said diffuser; said cutting control system including a control that is designed to process at least one type of detected information from at least one type of detector and to use such detected information to at least partially control a rate of cutting of said material by said diffuser, said detected information including information selected from the group consisting of pressure of said material prior to entering said die opening, pressure of said material in said die opening, temperature of said material prior to entering said die opening, temperature of said material in said die opening, velocity of said material prior to entering said die opening, velocity of said material in said die opening, velocity of said material exiting said die opening, change of velocity of said material prior to entering said die opening, change of velocity of said material in said die opening, change of velocity of said material exiting said die opening, length of said material being cut, temperature of said material, temperature of said die plate, temperature of auger blade, temperature of wiper blade, composition of said material, density of said material, time period required for said material to move through said die opening, time period for said material to move to said die plate, type of fluid flowing to said diffuser, flowrate of fluid to said diffuser, fluid pressure to said diffuser, fluid flowrate exiting said diffuser, fluid pressure exiting said diffuser, configuration of said diffuser, angle at which fluid flows from said diffuser toward said material exiting said die plate, plugging or clogging of said die opening, amount of vibration of said die plate, cavitation of said material moving toward said die plate, auger blade rotation speed, and combinations thereof.

12. The cutting assembly as defined in claim 10, including a cutting control system designed to at least partially control a rate of cutting of said material by said diffuser; said cutting control system including a control that is designed to process at least one type of detected information from at least one type of detector and to use such detected information to at least partially control a rate of cutting of said material by said diffuser, said detected information including information selected from the group consisting of pressure of said material prior to entering said die opening, pressure of said material in said die opening, temperature of said material prior to entering said die opening, temperature of said material in said die opening, velocity of said material prior to entering said die opening, velocity of said material in said die opening, velocity of said material exiting said die opening, change of velocity of said material prior to entering said die opening, change of velocity of said material in said die opening, change of velocity of said material exiting said die opening, length of said material being cut, temperature of said material, temperature of said die plate, temperature of auger blade, temperature of wiper blade, composition of said material, density of said material, time period required for said material to move through said die opening, time period for said material to move to said die plate, type of fluid flowing to said diffuser, flowrate of fluid to said diffuser, fluid pressure to said diffuser, fluid flowrate exiting said diffuser, fluid pressure exiting said differed, configuration of said diffuser, angle at which fluid flows from said diffuser toward said material exiting said die plate, plugging or clogging of said die opening, amount of vibration of said die plate, cavitation of said material moving toward said die plate, auger blade rotation speed, and combinations thereof.

13. The cutting assembly as defined in claim 1, including a data storage arrangement to store information, said information including information selected from the group consisting of pressure of said material prior to entering said die opening, pressure of said material in said die opening, temperature of said material prior to entering said die opening, temperature of said material in said die opening, velocity of said material prior to entering said die opening, velocity of said material in said die opening, velocity of said material exiting said die opening, change of velocity of said material prior to entering said die opening, change of velocity of said material in said die opening, change of velocity of said material exiting said die opening, length of said material being cut, temperature of said material, temperature of said die plate, temperature of auger blade, temperature of wiper blade, temperature of said diffuser, composition of said material, density of said material, time period required for said material to move through said die opening, time period for said material to move to said die plate, type of fluid flowing to said diffuser, flowrate of fluid to said diffuser, fluid pressure to said diffuser, fluid flowrate exiting said diffuser, fluid pressure exiting said differed, configuration of said diffuser, angle at which fluid flows from said diffuser toward said material exiting said die plate, plugging or clogging of said die opening, amount of vibration of said die plate, cavitation of said material moving toward said die plate, auger blade rotation speed, current weather conditions, type of extruder, extruder configuration, type of feeder for extruder, type of liner, material of liner, shape of liner, die plate size, die plate opening configuration, die plate opening size, material of the die plate, thickness of the die plate, die/extruder insert size, die/extruder insert shape, die/extruder insert thickness, die/extruder insert material, die/extruder insert hole profile, number of die/extruder inserts on die plate, type of auger blade; material of auger blade; shape of auger blade, size of auger blade, number of blades on wiper blade, type of wiper blade, spacing of wiper blade from die plate, spacing of wiper blade from die/extruder insert, wiper blade material, calculated and/or detected wear rates of at least components of the extruder and/or cutting assembly, time extruder components have extruded material, time period the cutting assembly has cut product, and combinations thereof.

14. The cutting assembly as defined in claim 12, including a data storage arrangement to store information, said information including information selected from the group consisting of pressure of said material prior to entering said die opening, pressure of said material in said die opening, temperature of said material prior to entering said die opening, temperature of said material in said die opening, velocity of said material prior to entering said die opening, velocity of said material in said die opening, velocity of said material exiting said die opening, change of velocity of said material prior to entering said die opening, change of velocity of said material in said die opening, change of velocity of said material exiting said die opening, length of said material being cut, temperature of said material, temperature of said die plate, temperature of auger blade, temperature of wiper blade, temperature of said diffuser, composition of said material, density of said material, time period required for said material to move through said die opening, time period for said material to move to said die plate, type of fluid flowing to said diffuser, flowrate of fluid to said diffuser, fluid pressure said diffuser, fluid flowrate exiting said diffuser, fluid pressure exiting said differed, configuration of said diffuser, angle at which fluid flows from said diffuser toward said material exiting said die plate, plugging or clogging of said die opening, amount of vibration of said die plate, cavitation of said material moving toward said die plate, auger blade rotation speed, current weather conditions, type of extruder, extruder configuration, type of feeder for extruder, type of liner, material of liner, shape of liner, die plate size, die plate opening configuration, die plate opening size, material of the die plate, thickness of the die plate, die/extruder insert size, die/extruder insert shape, die/extruder insert thickness, die/extruder insert material, die/extruder insert hole profile, number of die/extruder inserts on die plate, type of auger blade; material of auger blade; shape of auger blade, size of auger blade, number of blades on wiper blade, type of wiper blade, spacing of wiper blade from die plate, spacing of wiper blade from die/extruder insert, wiper blade material, calculated and/or detected wear rates of at least components of the extruder and/or cutting assembly, time extruder components have extruded material, time period the cutting assembly has cut product, and combinations thereof.
